(19) United States
(12) Patent Application Publication
(10) Pub. No.: US 2006/0277335 A1
(43) Pub. Date: Dec. 7, 2006

(54) Peripheral device for use with computer system

(75) Inventor: Chih-Feng Chien, Taipei (TW)

Correspondence Address: BERKELEY LAW & TECHNOLOGY GROUP, 1700NW 167TH PLACE, SUITE 240, BEAVERTON, OR, 97006, US

(73) Assignee: Primax Electronics Ltd.

(21) Appl. No.: 11/189,670

(22) Filed: Jul. 26, 2005

(30) Foreign Application Priority Data
Jun. 3, 2005 (TW) 094118328

(51) Int. Cl. G06F 13/38

(52) U.S. Cl. 710/62

(57) ABSTRACT

A peripheral device includes a housing, a first-type connector, a micro-controller and an adapter. The first-type connector includes first and second groups of pins. The micro-controller is electrically connected to the first and second groups of pins. When the second group of pins is detected to be in a first operating state, a first signal transmission is performed to communicate with the computer system via the first group of pins. The adapter has a first terminal electrically connectable to the first-type connector and a second terminal serving as a second-type connector. The second group of pins is detected to be in a second operating state when the first terminal of the adapter is electrically connected to the first and second groups of pins such that the micro-controller performs a second signal transmission to communicate with the computer system via the first group of pins and the second-type connector.

### FIELD OF THE INVENTION

The present invention relates to a peripheral device, and more particularly to a peripheral device for use with a computer system.

### BACKGROUND OF THE INVENTION

Referring to FIG. 1, two connecting ports commonly used to communicate peripheral devices with a computer system are illustrated. For example, the connecting ports 10 and 11 are universal serial bus (USB) and PS/2 ports, respectively. As shown in FIG. 1, the shapes and the arrangements of these two connecting ports are very distinguished. In addition, the signal transmission approaches of using these two connecting ports are largely different. In other words, the peripheral device conforming to the PS/2 port fails to be compatible with the USB port. Since it is not easy to realize whether the computer system has any PS/2 port and memorize the number of the USB ports, a peripheral device capable of supporting both the PS/2 port and the USB port was disclosed for example in U.S. Pat. Nos. 6,625,790 B1, 6,725,318 B1 and 6,460,094 B1, and the contents of which are hereby incorporated by reference. According to these teachings, the signal transmission between the peripheral device and the computer system is determined by using the peripheral device to detect the specific feature of the USB signal or the PS/2 signal sent from the computer side. The technologies of utilizing the feature difference between the USB signal and the PS/2 signal, however, have several drawbacks. For example, the circuitry involving in designing the peripheral device is complicated. In addition, due to the difference between various computer systems, erroneous determination may occur.

In views of the above-described disadvantages resulted from the prior art, the applicant keeps on carving unflaggingly to develop a peripheral device for use with a computer system according to the present invention through wholehearted experience and research.

### SUMMARY OF THE INVENTION

In accordance with a first aspect of the present invention, there is provided a peripheral device electrically connectable to a computer system. The peripheral device comprises a housing, a first-type connector, a micro-controller and an adapter. The first-type connector protrudes out of the housing, and comprises a first group of pins and a second group of pins. The micro-controller is disposed within the housing and electrically connected to the first group of pins and the second group of pins of the first-type connector. When the second group of pins is detected to be in a first operating state, a first signal transmission is performed to communicate with the computer system via the first group of pins. The adapter has a first terminal electrically connectable to the first-type connector and a second terminal serving as a second-type connector. The second group of pins is detected to be in a second operating state when the first terminal of the adapter is electrically connected to the first group of pins and the second group of pins of the first-type connector such that the micro-controller performs a second signal transmission to communicate with the computer system via the first group of pins and the second-type connector.

In an embodiment, the peripheral device is a mouse or a keyboard, the first-type connector is a USB connector, and the second-type connector is a PS/2 connector.

In an embodiment, the second group of pins comprises a first connecting line and a second connecting line disconnected with each other. The first operating state of the second group of pins detected by the micro-controller is an interruption state. The second operating state of the second group of pins detected by the micro-controller is a conduction state when the first terminal of the adapter is electrically connected to the second group of pins of the first-type connector to permit communication between the first connecting line and the second connecting line

In an embodiment, the second group of pins comprises a first connecting line connected to a ground portion. The first operating state of the second group of pins detected by the micro-controller is a grounding state. The second operating state of the second group of pins detected by the micro-controller is a high voltage state when the first terminal of the adapter is electrically connected to the second group of pins of the first-type connector to permit communication between the first connecting line and a power source.

In accordance with a second aspect of the present invention, there is provided a peripheral device electrically connectable to a computer system. The peripheral device comprises a housing, a first-type connector, a micro-controller and an adapter. The first-type connector protrudes out of the housing, and comprises a first group of pins and a detecting circuit. The micro-controller is disposed within the housing and electrically connected to the first group of pins and the detecting circuit of the first-type connector. When the detecting circuit is detected to be in a first operating state, a first signal transmission is performed to communicate with the computer system via the first group of pins. The adapter has a first terminal electrically connectable to the first-type connector and in signal communication with the detecting circuit and a second terminal serving as a second-type connector. The detecting circuit is detected to be in a second operating state by the micro-controller when the first terminal of the adapter is electrically connected to the first group of pins and in signal communication with the detecting circuit such that the micro-controller performs a second signal transmission to communicate with the computer system via the first group of pins and the second-type connector.

In an embodiment, the detecting circuit comprises a phototransistor. The first operating state of the detecting circuit detected by the micro-controller is a grounding state. The second operating state of the detecting circuit detected by the micro-controller is a high voltage state when an IR diode at the first terminal of the adapter is electrically connected to the first group of pins of the first-type connector to illuminate a light to permit communication between the phototransistor and the a power source.

In an embodiment, the detecting circuit comprises a detecting pin. The first operating state of the detecting circuit detected by the micro-controller is a grounding state. The second operating state of the detecting circuit detected by the micro-controller is a high voltage state when the first terminal of the adapter is electrically connected to the detecting pin of the first-type connector to permit communication between the first connecting line and a power source.

In accordance with a third aspect of the present invention, there is provided a peripheral device electrically connectable to a computer system. The peripheral device comprises a housing, a first-type connector, a micro-controller and an adapter. The first-type connector protrudes out of the housing, and comprises a first group of pins and a detecting circuit. The micro-controller is disposed within the housing, and electrically connected to the first group of pins and the detecting circuit of the first-type connector. When the detecting circuit is detected to be in a first operating state, a first signal transmission is performed to communicate with the computer system via the first group of pins when. The adapter has a first terminal electrically connectable to the first-type connector and a second terminal serving as a second-type connector. The detecting circuit is detected to be in a second operating state in response to an external force when the first terminal of the adapter is electrically connected to the first group of pins such that the micro-controller performs a second signal transmission to communicate with the computer system via the first group of pins and the second-type connector.

In an embodiment, the detecting circuit comprises a detecting switch. The first operating state of the detecting circuit detected by the micro-controller is a grounding state. The second operating state of the detecting circuit detected by the micro-controller is a high voltage state when the adapter is electrically connected to the first-type connector to push forwardly a sustaining element on the detecting switch to interrupt the detecting switch.

In an embodiment, the detecting circuit comprises a manual switch. The second operating state of the detecting circuit detected by the micro-controller is a grounding state when the adapter is electrically connected to the first-type connector and the manual switch is switched to permit conduction of the detecting circuit.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic layout diagram illustrating two connecting ports commonly used to communicate peripheral devices with a computer system according to prior art;

FIGS. 2(a), 2(b) and 2(c) are schematic circuit block diagram, flowchart diagram and schematic layout diagram of a peripheral device capable of supporting plural transmission interfaces according to a first preferred embodiment of the present invention, respectively;

FIGS. 2(d), 2(e) and 2(f) are schematic circuit block diagram, flowchart diagram and schematic layout diagram of a peripheral device capable of supporting plural transmission interfaces according to a second preferred embodiment of the present invention, respectively;

FIGS. 3(a), 3(b) and 3(c) are schematic circuit block diagram, flowchart diagram and schematic layout diagram of a peripheral device capable of supporting plural transmission interfaces according to a third preferred embodiment of the present invention, respectively;

FIGS. 3(d), 3(e) and 3(f) are schematic circuit block diagram, flowchart diagram and schematic layout diagram of a peripheral device capable of supporting plural transmission interfaces according to a fourth preferred embodiment of the present invention, respectively;

FIGS. 4(a), 4(b) and 4(c) are schematic circuit block diagram, flowchart diagram and schematic layout diagram of a peripheral device capable of supporting plural transmission interfaces according to a fifth preferred embodiment of the present invention, respectively; and

FIGS. 4(d), 4(e) and 4(f) are schematic circuit block diagram, flowchart diagram and schematic layout diagram of a peripheral device capable of supporting plural transmission interfaces according to a sixth preferred embodiment of the present invention, respectively.

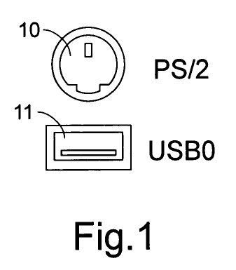

### DETAILED DESCRIPTION OF THE PREFERRED EMBODIMENT

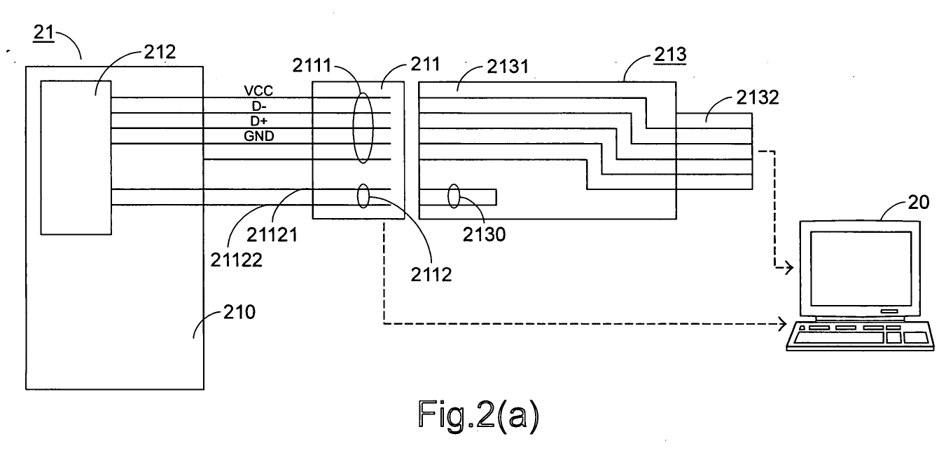

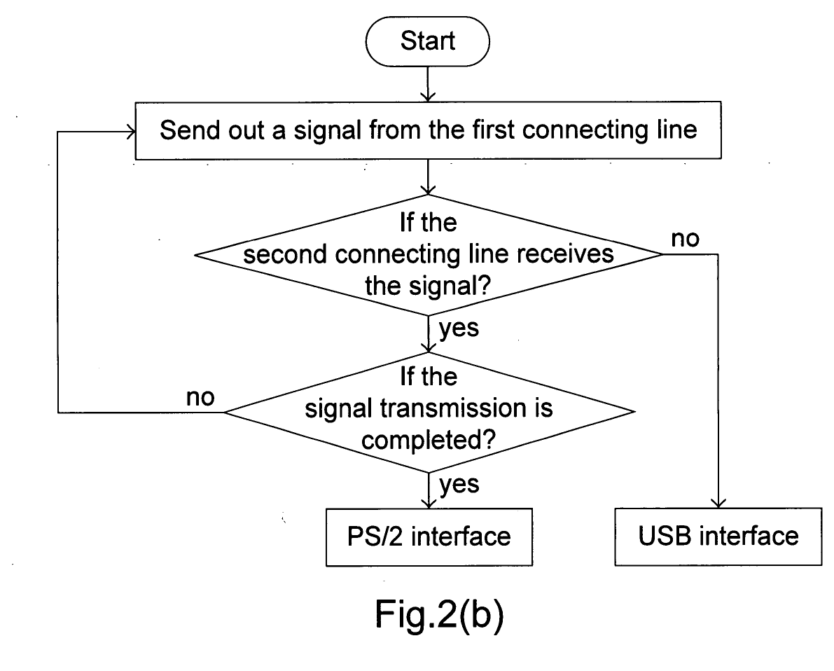

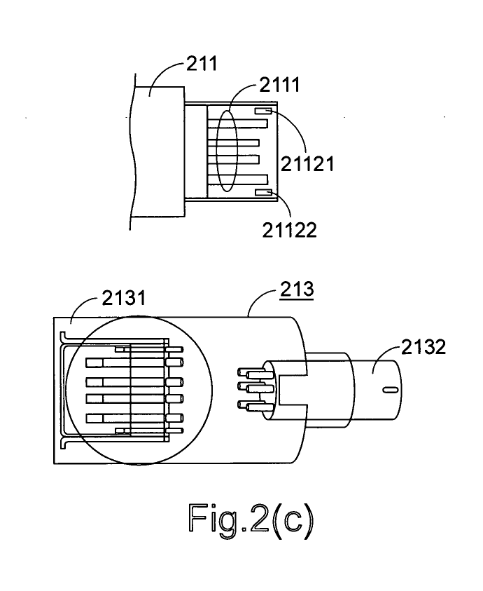

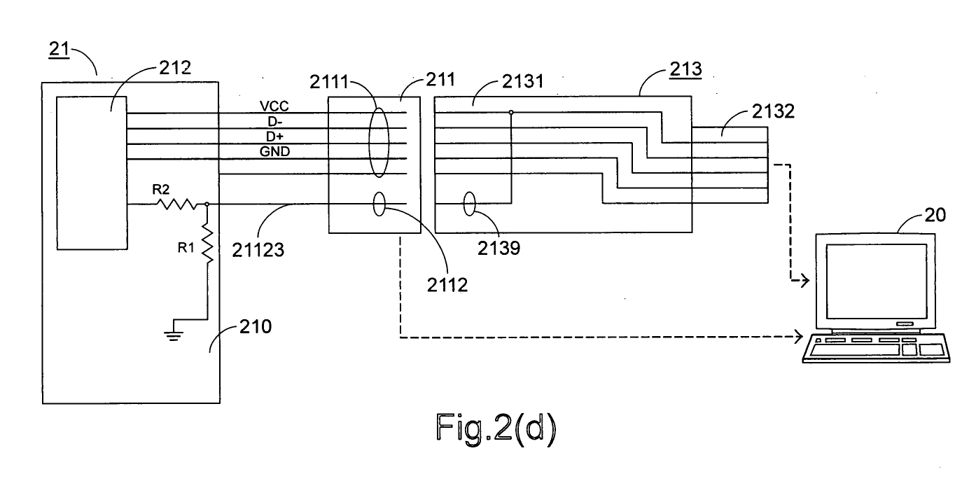

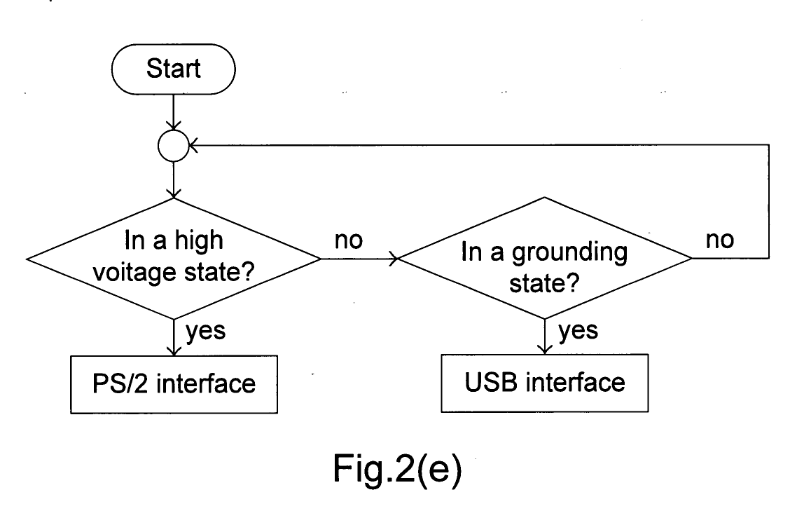

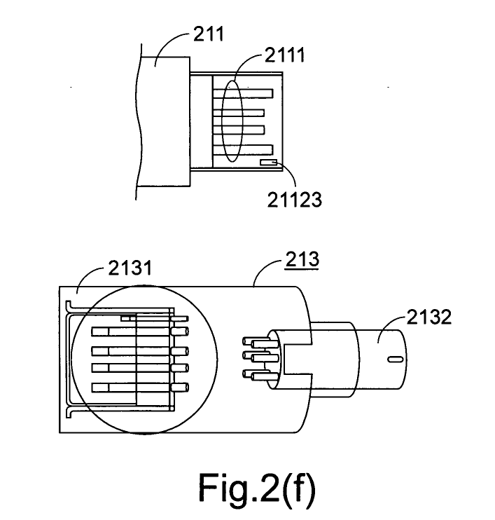

Referring to FIG. 2(a), a schematic circuit block diagram of a peripheral device capable of supporting plural transmission interfaces according to a first preferred embodiment of the present invention is illustrated. The peripheral device 21 such as a mouse or a keyboard is electrically connected to a computer system 20. The peripheral device 21 comprises a housing 210, a first-type connector 211, a micro-controller 212 and an adapter 213. Since the universal serial bus (USB) connector and the PS/2 connector are widely used as the signal connectors for the peripheral devices, these two types of signal connectors will be taken as examples to illustrate the peripheral device of the present invention in more details as follows. As shown in FIG. 2(a), an example of the first-type connector 211 is a USB connector, which includes a first group of pins 2111 and a second group of pins 2112. The second group of pins 2112 comprises a first connecting line 21121 and a second connecting line 21122, which are disconnected with each other. In a case that a control signal is issued from the micro-controller 212, the control signal will be sent out from the first connecting line 21121 but fails to be read by the micro-controller 212 from the second connecting line 21122. In this circumstance, the second group of pins 2112 is detected to be in an interruption state. Accordingly, it is discriminated that the USB connector is employed to perform signal transmission between the peripheral device 21 and the computer system 20. On the other hand, in a case that a first terminal 2131 of the adapter 213 is electrically connected to the first-type connector 211, the first connecting line 21121 is communicated with the second connecting line 21122 via a connecting line 2130. Meanwhile, the control signal issued from the micro-controller 212 would be sent out from the first connecting line 21121 and read by the micro-controller 212 from the second connecting line 21122. In this circumstance, the second group of pins 2112 is detected to be in a conduction state. Accordingly, it is discriminated that the PS/2 connector at the second terminal 2132 of the adapter 213 is employed to perform signal transmission between the peripheral device 21 and the computer system 20. The process of discriminating which type of connector to be utilized in the first preferred embodiment will be illustrated with reference to FIG. 2(b).

Please refer to FIG. 2(c), which is a schematic layout diagram illustrating the first-type connector 211 and the adapter 213 used in the first embodiment of the present invention. As shown, the first-type connector 211, i.e. the USB connector, further comprises two connecting lines 21121 and 21122. It is noted that, however, those skilled in the art will readily observe that numerous modifications and alterations of the connectors' types may be made while retaining the teachings of the invention. For example, the PS/2 connector and the USB connector can be used as the first-type connector 211 and the second terminal 2132 of the adapter 213, respectively.

Referring to FIG. 2(d), a schematic circuit block diagram of a peripheral device capable of supporting plural transmission interfaces according to a second preferred embodiment of the present invention is illustrated. The peripheral device of FIG. 2(d) is substantially similar to that of the first embodiment except that the second group of pins 2112 used in the first-type connector 211 has only one connecting line 21123. The connecting line 21123 is connected to the ground portion and the micro-controller 212 via the resistors R1 and R2, respectively. The resistance of the resistor R1 is much higher than that of the resistor R2. In a case that the second group of pins 2112 is originally in the grounding state, it is discriminated that the USB connector is used to perform signal transmission between the peripheral device 21 and the computer system 20. On the other hand, in a case that the first terminal 2131 of the adapter 213 is electrically connected to the first-type connector 211, the connecting line 21123 is communicated with the power source Vcc via a connecting line 2139. In this circumstance, the second group of pins 2112 detected by the micro-controller 212 is in a high voltage state. Accordingly, it is discriminated that the PS/2 connector at the second terminal 2132 of the adapter 213 is used to perform signal transmission between the peripheral device 21 and the computer system 20. The process of discriminating which type of connector to be utilized in the second preferred embodiment will be illustrated with reference to FIG. 2(e).

Please refer to FIG. 2(f), which is a schematic layout diagram illustrating the first-type connector 211 and the adapter 213 used in the second embodiment of the present invention. As shown, the first-type connector 211, i.e. the USB connector, further comprises a connecting line 21123. It is noted that, however, those skilled in the art will readily observe that numerous modifications and alterations of the connectors' types may be made while retaining the teachings of the invention. For example, the PS/2 connector and the USB connector can be used as the first-type connector 211 and the second terminal 2132 of the adapter 213, respectively. The operation principles thereof are similar to those mentioned in the above embodiment, are not to be described redundantly herein.

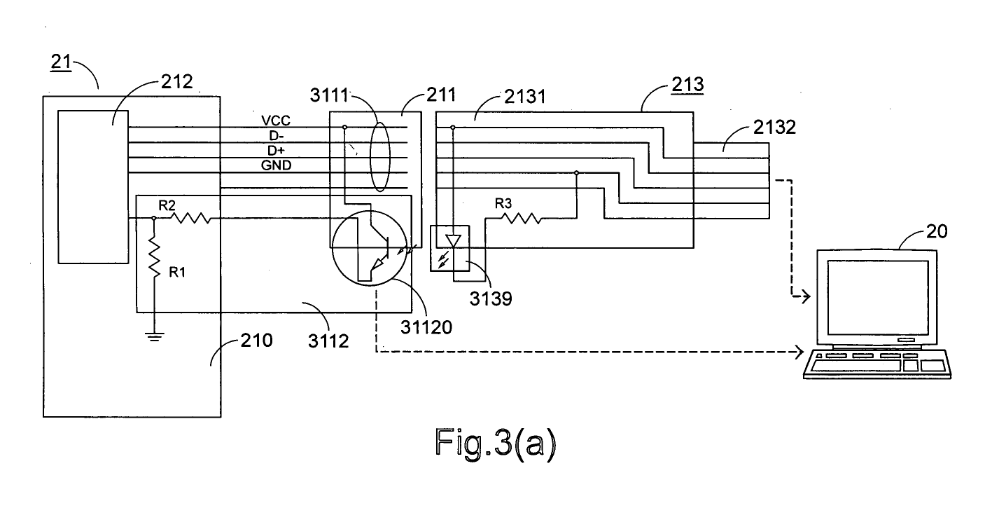

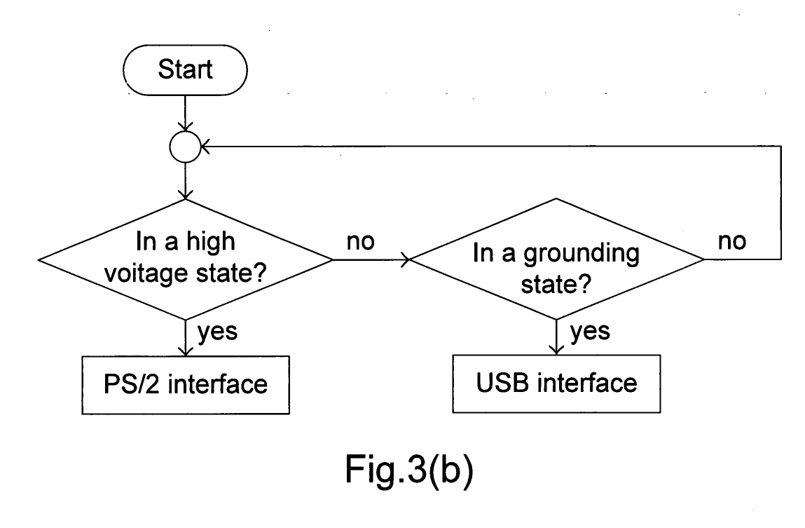

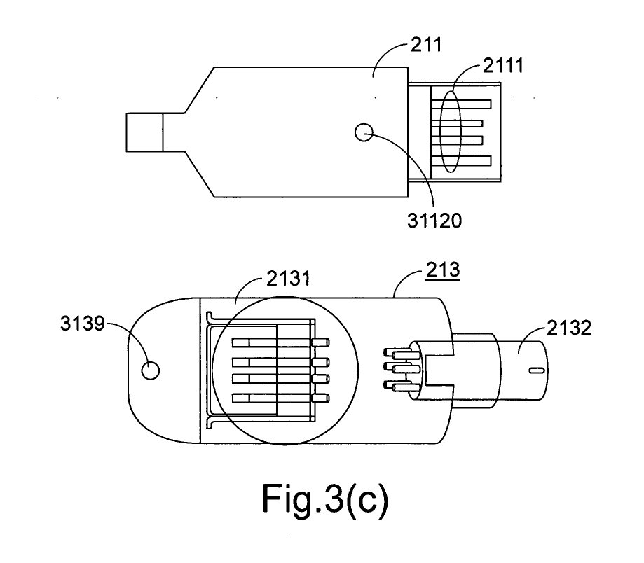

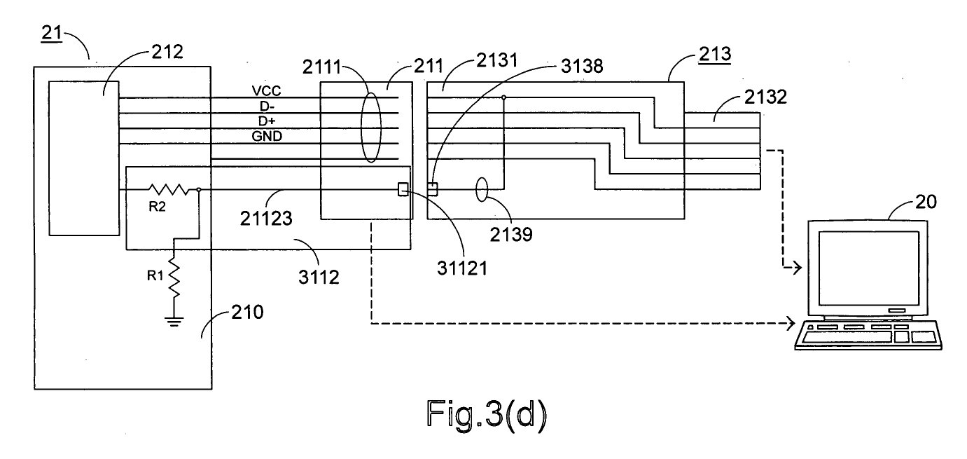

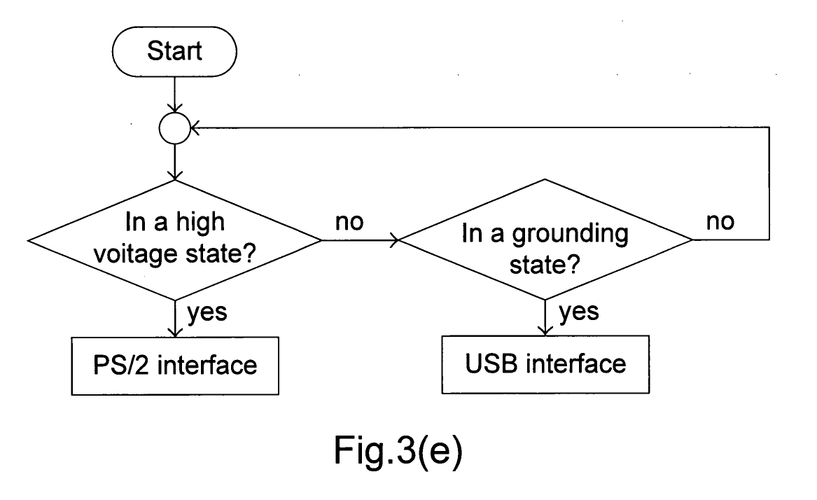

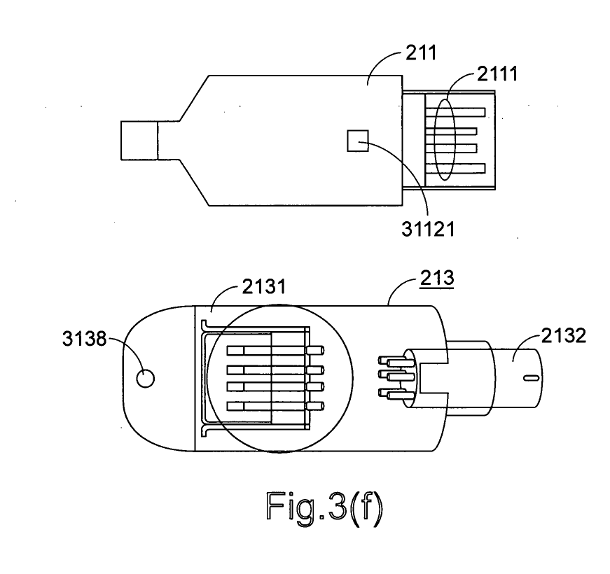

Referring to FIG. 3(a), a schematic circuit block diagram of a peripheral device capable of supporting plural transmission interfaces according to a third preferred embodiment of the present invention is illustrated. The peripheral device 21 such as a mouse or a keyboard is electrically connected to a computer system 20. The peripheral device 21 comprises a housing 210, a first-type connector 211, a micro-controller 212 and an adapter 213. Since the universal serial bus (USB) connector and the PS/2 connector are widely used as the signal connectors for the peripheral devices, these two types of connectors will be taken as examples to illustrate the peripheral device of the present invention in more details as follows.

As shown in FIG. 3(a), an example of the first-type connector 211 is a USB connector, which includes a first group of pins 2111 and a detecting circuit 3112. The detecting circuit 3112 is connected to the ground portion and the micro-controller 212 via the resistors R1 and R2, respectively. The resistance of the resistor R1 is much higher than that of the resistor R2. In a case that the detecting circuit 3112 detected by the micro-controller 212 is in a first operating state, e.g. a grounding state, it is discriminated that the USB connector is used to perform signal transmission between the peripheral device 21 and the computer system 20. On the other hand, in a case that the first terminal 2131 of the adapter 213 is electrically connected to the first-type connector 211, the detecting circuit 3112 detected by the micro-controller 212 is changed into a second operating state, e.g. a high voltage state, because an IR diode 3139 of the adapter 213 illuminates a light to permit conduction of a phototransistor 31120 included in the detecting circuit 3112. In this circumstance, the resistor R1 detected by the micro-controller 212 is in the high voltage state, and thus it is discriminated that the PS/2 connector at the second terminal 2132 of the adapter 213 is used to perform signal transmission between the peripheral device 21 and the computer system 20. The process of discriminating which type of connector to be utilized in the third preferred embodiment will be illustrated with reference to FIG. 3(b).

Please refer to FIG. 3(c), which is a schematic layout diagram illustrating the first-type connector 211 and the adapter 213 used in the third embodiment of the present invention. As shown, no addition signal connector is arranged on the first-type connector 211 (i.e. the USB connector), but the IR diode 3139 and the phototransistor 31120 should be arranged on the corresponding locations of the first-type connector 211 and the adapter 213. It is noted that, however, those skilled in the art will readily observe that numerous modifications and alterations of the connectors' types may be made while retaining the teachings of the invention. For example, the PS/2 connector and the USB connector can be used as the first-type connector 211 and the second terminal 2132 of the adapter 213, respectively. The operation principles thereof are similar to those mentioned in the above embodiment, are not to be described redundantly herein.

Referring to FIG. 3(d), a schematic circuit block diagram of a peripheral device capable of supporting plural transmission interfaces according to a fourth preferred embodiment of the present invention is illustrated. The peripheral device 21 such as a mouse or a keyboard is electrically connected to a computer system 20. The peripheral device 21 comprises a housing 210, a first-type connector 211, a micro-controller 212 and an adapter 213. Since the universal serial bus (USB) connector and the PS/2 connector are widely used as the signal connectors for the peripheral devices, these two types of connectors will be taken as examples to illustrate the peripheral device of the present invention in more details as follows.

As shown in FIG. 3(d), an example of the first-type connector 211 is a USB connector, which includes a first group of pins 2111 and a detecting circuit 3112. The detecting circuit 3112 is connected to the ground portion and the micro-controller 212 via the resistors R1 and R2, respectively. The resistance of the resistor R1 is much higher than that of the resistor R2. In a case that the detecting circuit 3112 detected by the micro-controller 212 is in a first operating state, e.g. a grounding state, it is discriminated that the USB connector is used to perform signal transmission between the peripheral device 21 and the computer system 20. On the other hand, in a case that the first terminal 2131 of the adapter 213 is electrically connected to the first-type connector 211, the detecting circuit 3112 detected by the micro-controller 212 is changed into a second operating state, e.g. a high voltage state, because a contact point 3138 of the adapter 213 permits conduction of a detecting pin 31121 in the detecting circuit 3112. In this circumstance, the resistor R1 detected by the micro-controller 212 is in the high voltage state, and thus it is discriminated that the PS/2 connector at the second terminal 2132 of the adapter 213 is used to perform signal transmission between the peripheral device 21 and the computer system 20. The process of discriminating which type of connector to be utilized in the fourth preferred embodiment will be illustrated with reference to FIG. 3(e).

Please refer to FIG. 3(f), which is a schematic layout diagram illustrating the first-type connector 211 and the adapter 213 used in the fourth embodiment of the present invention. As shown, no addition signal connector is arranged on the first-type connector 211 (i.e. the USB connector), but the contact point 3138 and the detecting pin 31121 should be arranged on the corresponding locations of the first-type connector 211 and the adapter 213. It is noted that, however, those skilled in the art will readily observe that numerous modifications and alterations of the connectors' types may be made while retaining the teachings of the invention. For example, the PS/2 connector and the USB connector can be used as the first-type connector 211 and the second terminal 2132 of the adapter 213, respectively. The operation principles thereof are similar to those mentioned in the above embodiment, are not to be described redundantly herein.

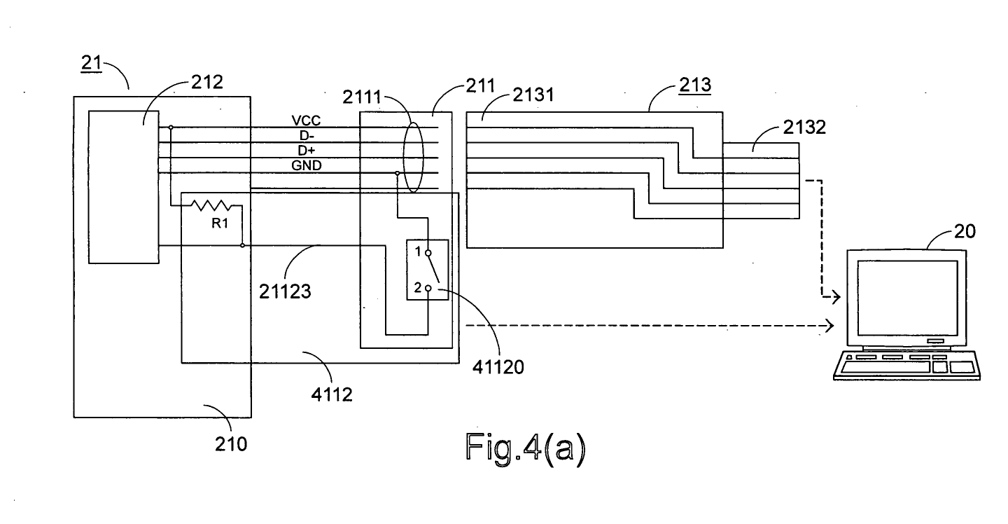

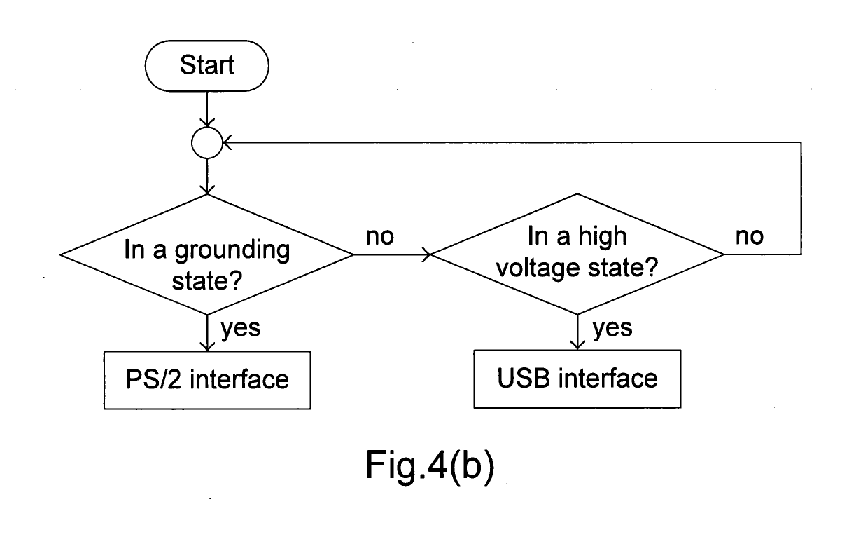

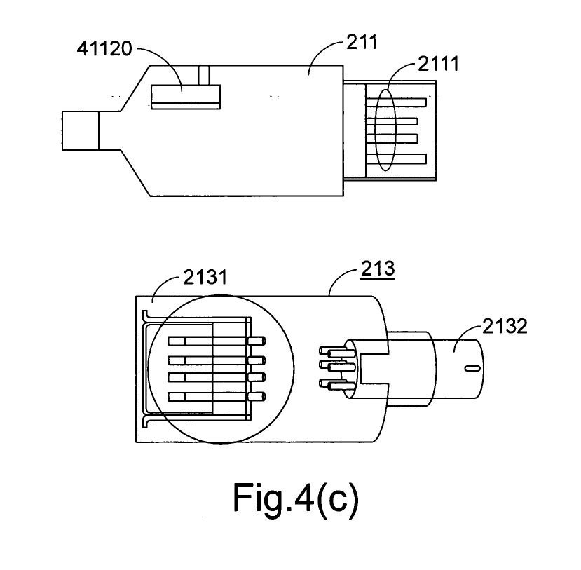

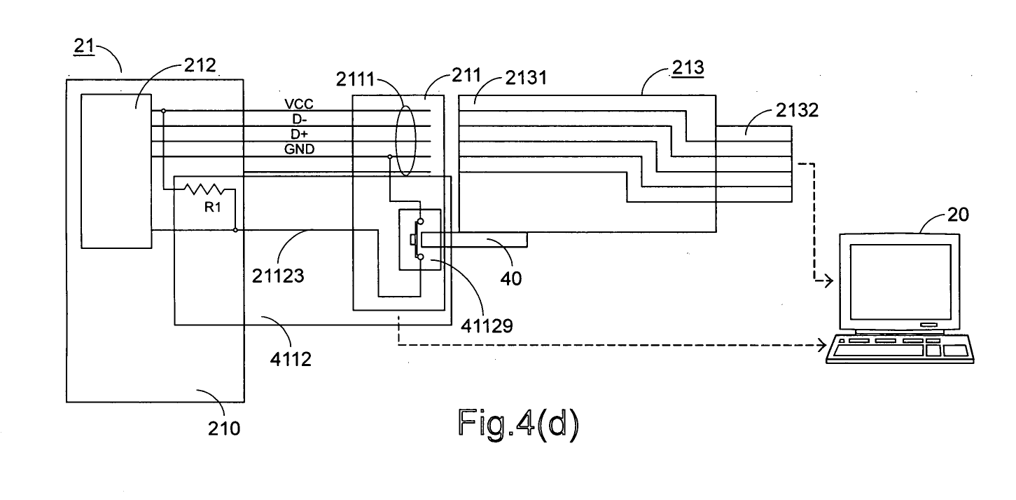

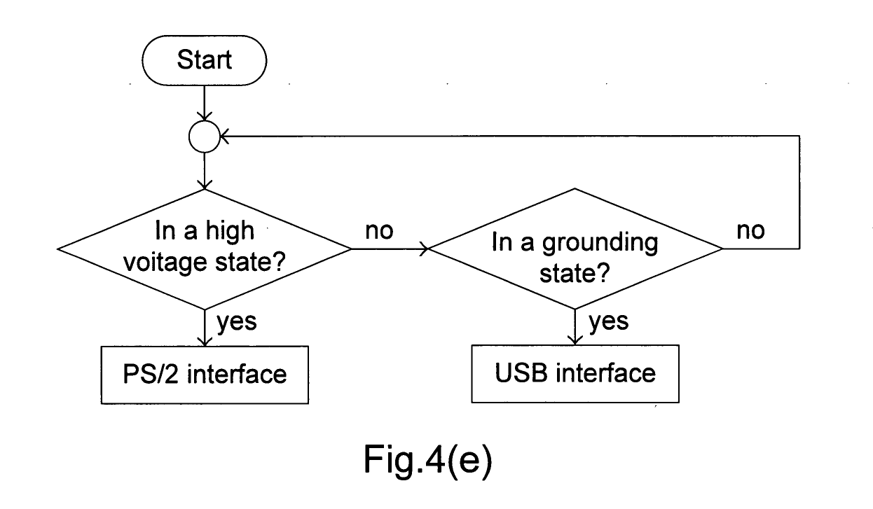

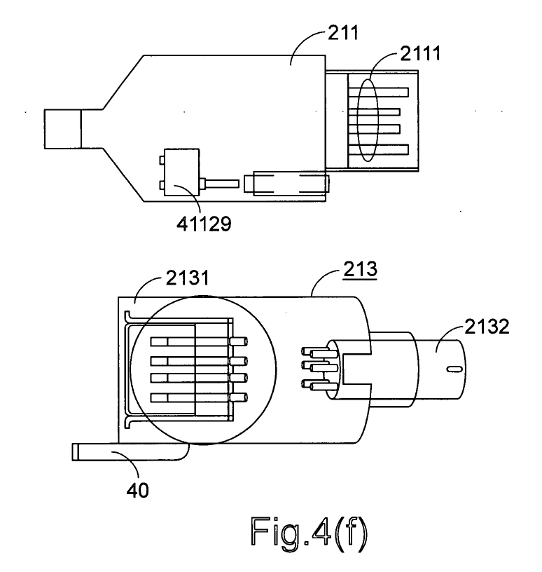

Referring to FIG. 4(a), a schematic circuit block diagram of a peripheral device capable of supporting plural transmission interfaces according to a fifth preferred embodiment of the present invention is illustrated. The peripheral device 21 such as a mouse or a keyboard is electrically connected to a computer system 20. The peripheral device 21 comprises a housing 210, a first-type connector 211, a micro-controller 212 and an adapter 213. Since the universal serial bus (USB) connector and the PS/2 connector are widely used as the signal connectors for the peripheral devices, these two types of connectors will be taken as examples to illustrate the peripheral device of the present invention in more details as follows.

As shown in FIG. 4(a), an example of the first-type connector 211 is a USB connector, which includes a first group of pins 2111 and a detecting circuit 4112. In a case that the detecting circuit 4112 detected by the micro-controller 212 is in a first operating state, e.g. a high voltage state, it is discriminated that the USB connector is used to perform signal transmission between the peripheral device 21 and the computer system 20. On the other hand, in a case that the first terminal 2131 of the adapter 213 is electrically connected to the first-type connector 211, the detecting circuit 4112 detected by the micro-controller 212 is changed into a second operating state, e.g. a grounding state, because a manual switch 41120 is switched to permit conduction between the micro-controller 212 and the ground portion. In this circumstance, thus it is discriminated that the PS/2 connector at the second terminal 2132 of the adapter 213 is used to perform signal transmission between the peripheral device 21 and the computer system 20. The process of discriminating which type of connector to be utilized in the fifth preferred embodiment will be illustrated with reference to FIG. 4(b).

Please refer to FIG. 4(c), which is a schematic layout diagram illustrating the first-type connector 211 and the adapter 213 used in the fifth embodiment of the present invention. As shown, no addition signal connector is arranged on the first-type connector 211 (i.e. the USB connector), but the manual switch 41120 is arranged on the housing of the first-type connector 211. It is noted that, however, those skilled in the art will readily observe that numerous modifications and alterations of the connectors' types may be made while retaining the teachings of the invention. For example, the PS/2 connector and the USB connector can be used as the first-type connector 211 and the second terminal 2132 of the adapter 213, respectively. The operation principles thereof are similar to those mentioned in the above embodiment, are not to be described redundantly herein.

Referring to FIG. 4(d), a schematic circuit block diagram of a peripheral device capable of supporting plural transmission interfaces according to a sixth preferred embodiment of the present invention is illustrated. The peripheral device 21 such as a mouse or a keyboard is electrically connected to a computer system 20. The peripheral device 21 comprises a housing 210, a first-type connector 211, a micro-controller 212 and an adapter 213. Since the universal serial bus (USB) connector and the PS/2 connector are widely used as the signal connectors for the peripheral devices, these two types of connectors will be taken as examples to illustrate the peripheral device of the present invention in more details as follows.

As shown in FIG. 4(d), an example of the first-type connector 211 is a USB connector, which includes a first group of pins 2111 and a detecting circuit 4112. In a case that the detecting circuit 4112 detected by the micro-controller 212 is in a first operating state, e.g. a grounding state, it is discriminated that the USB connector is used to perform signal transmission between the peripheral device 21 and the computer system 20. On the other hand, in a case that the first terminal 2131 of the adapter 213 is electrically connected to the first-type connector 211, the detecting circuit 4112 detected by the micro-controller 212 is changed into a second operating state, e.g. a high voltage state, because a sustaining element 40 is pushed forwardly to interrupt the detecting switch 41129. In this circumstance, it is discriminated that the PS/2 connector at the second terminal 2132 of the adapter 213 is used to perform signal transmission between the peripheral device 21 and the computer system 20. The process of discriminating which type of connector to be utilized in the sixth preferred embodiment will be illustrated with reference to FIG. 4(e).

Please refer to FIG. 4(f), which is a schematic layout diagram illustrating the first-type connector 211 and the adapter 213 used in the sixth embodiment of the present invention. As shown, no addition signal connector is arranged on the first-type connector 211, i.e. the USB connector, but the detecting switch 41129 and the sustaining element 40 are arranged on the housing of the first-type connector 211 and the adapter 213, respectively. It is noted that, however, those skilled in the art will readily observe that numerous modifications and alterations of the connectors' types may be made while retaining the teachings of the invention. For example, the PS/2 connector and the USB connector can be used as the first-type connector 211 and the second terminal 2132 of the adapter 213, respectively. The operation principles thereof are similar to those mentioned in the above embodiment, are not to be described redundantly herein.

From the above description, the peripheral device provided by the present invention is capable of supporting plural transmission interfaces. In addition, the peripheral device of the present invention has benefits of simpler configuration, more cost effectiveness and lower erroneous rate when compared with the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A peripheral device electrically connectable to a computer system, said peripheral device comprising:
a housing;
a first-type connector protruding out of said housing, and comprising a first group of pins and a second group of pins;
a micro-controller disposed within said housing, electrically connected to said first group of pins and said second group of pins of said first-type connector, and performing a first signal transmission to communicate with said computer system via said first group of pins when said second group of pins is detected to be in a first operating state; and
an adapter having a first terminal electrically connectable to said first-type connector and a second terminal serving as a second-type connector, wherein said second group of pins is detected to be in a second operating state when said first terminal of said adapter is electrically connected to said first group of pins and said second group of pins of said first-type connector such that said micro-controller performs a second signal transmission to communicate with said computer system via said first group of pins and said second-type connector.

2. The peripheral device according to claim 1 wherein said peripheral device is a mouse or a keyboard, said first-type connector is a USB connector, and said second-type connector is a PS/2 connector.

3. The peripheral device according to claim 1 wherein said second group of pins comprises a first connecting line and a second connecting line disconnected with each other, said first operating state of said second group of pins detected by said micro-controller is an interruption state, and said second operating state of said second group of pins detected by said micro-controller is a conduction state when said first terminal of said adapter is electrically connected to said second group of pins of said first-type connector to permit communication between said first connecting line and said second connecting line.

4. The peripheral device according to claim 1 wherein said second group of pins comprises a first connecting line connected to a ground portion, said first operating state of said second group of pins detected by said micro-controller is a grounding state, and said second operating state of said second group of pins detected by said micro-controller is a high voltage state when said first terminal of said adapter is electrically connected to said second group of pins of said first-type connector to permit communication between said first connecting line and a power source.

5. A peripheral device electrically connectable to a computer system, said peripheral device comprising:
a housing;
a first-type connector protruding out of said housing, and comprising a first group of pins and a detecting circuit;
a micro-controller disposed within said housing, electrically connected to said first group of pins and said detecting circuit of said first-type connector, and performing a first signal transmission to communicate with said computer system via said first group of pins when said detecting circuit is detected to be in a first operating state; and
an adapter having a first terminal electrically connectable to said first-type connector and in signal communication with said detecting circuit and a second terminal serving as a second-type connector, wherein said detecting circuit is detected to be in a second operating state by said micro-controller when said first terminal of said adapter is electrically connected to said first group of pins and in signal communication with said detecting circuit such that said micro-controller performs a second signal transmission to communicate with said computer system via said first group of pins and said second-type connector.

6. The peripheral device according to claim 5 wherein said peripheral device is a mouse or a keyboard, said first-type connector is a USB connector, and said second-type connector is a PS/2 connector.

7. The peripheral device according to claim 5 wherein said detecting circuit comprises a phototransistor, said first operating state of said detecting circuit detected by said micro-controller is a grounding state, and said second operating state of said detecting circuit detected by said micro-controller is a high voltage state when an IR diode at said first terminal of said adapter is electrically connected to said first group of pins of said first-type connector to illuminate a light to permit communication between said phototransistor and said a power source.

8. The peripheral device according to claim 5 wherein said detecting circuit comprises a detecting pin, said first operating state of said detecting circuit detected by said micro-controller is a grounding state, and said second operating state of said detecting circuit detected by said micro-controller is a high voltage state when said first terminal of said adapter is electrically connected to said detecting pin of said first-type connector to permit communication between said first connecting line and a power source.

9. A peripheral device electrically connectable to a computer system, said peripheral device comprising:
a housing;
a first-type connector protruding out of said housing, and comprising a first group of pins and a detecting circuit;
a micro-controller disposed within said housing, electrically connected to said first group of pins and said detecting circuit of said first-type connector, and performing a first signal transmission to communicate with said computer system via said first group of pins when said detecting circuit is detected to be in a first operating state; and
an adapter having a first terminal electrically connectable to said first-type connector and a second terminal serving as a second-type connector, wherein said detecting circuit is detected to be in a second operating state in response to an external force when said first terminal of said adapter is electrically connected to said first group of pins such that said micro-controller performs a second signal transmission to communicate with said computer system via said first group of pins and said second-type connector.

10. The peripheral device according to claim 9 wherein said peripheral device is a mouse or a keyboard, said first-type connector is a USB connector, and said second-type connector is a PS/2 connector.

11. The peripheral device according to claim 9 wherein said detecting circuit comprises a detecting switch, said first operating state of said detecting circuit detected by said micro-controller is a grounding state, and said second operating state of said detecting circuit detected by said micro-controller is a high voltage state when said adapter is electrically connected to said first-type connector to push forwardly a sustaining element on said detecting switch to interrupt said detecting switch.

12. The peripheral device according to claim 9 wherein said detecting circuit comprises a manual switch, and said second operating state of said detecting circuit detected by said micro-controller is a grounding state when said adapter is electrically connected to said first-type connector and said manual switch is switched to permit conduction of said detecting circuit.
